(19) United States
(12) Patent Application Publication
(10) Pub. No.: US 2016/0379215 A1
(43) Pub. Date: Dec. 29, 2016

(54) METHOD AND SYSTEM FOR SUPERVISORY CONTROL OF PAYMENT TRANSACTIONS

(71) Applicant: MasterCard International Incorporated, Purchase, NY (US)

(72) Inventor: John CLERKIN, Greystones (IE)

(73) Assignee: MasterCard International Incorporated, Purchase, NY (US)

(21) Appl. No.: 14/753,440

(22) Filed: Jun. 29, 2015

(51) Int. Cl. G06Q 20/40; G06Q 20/42

(52) U.S. Cl. CPC G06Q 20/401; G06Q 20/42

(57) ABSTRACT

A method for facilitating supervisory control of payment transactions initiated using a computing device includes: storing account profiles, each including a first identifier, second identifier, and transaction controls; receiving transaction details from a second device for a payment transaction, the transaction details including a second identifier and transaction data values; identifying a specific profile that includes the second identifier; determining that the payment transaction does not satisfy the transaction controls in the specific profile based the transaction data values; transmitting a confirmation request including the transaction data values to the first device associated with the first identifier in the specific profile; receiving a confirmation message from the first device indicating approval or denial of the payment transaction; and transmitting a message to at least one of: the second device, a payment network, and a merchant involved in the payment transaction based on the indication.

### FIELD

The present disclosure relates to the supervisory control of payment transactions, specifically the use of multiple computing devices where a payment transaction that exceeds a threshold initiated using a first computing device is supervised and controlled via a second computing device.

### BACKGROUND

Payment transactions may be paid for by a consumer using a variety of different payment instruments, such as cash, check, credit card, debit card, gift certificate, etc. While many payment instruments may be issued directly to a specific consumer, often times these instruments are able to be transferred by the consumer to other individuals for use. In some cases, the primary consumer to whom the instrument is issued may wish to monitor usage of the instrument. For instance, parents may give their child a credit card to use in a transaction, or an employer may give an employee a credit card associated with a corporate account, but may want to check up on the transactions for which the card is used, to ensure that any limitations are followed.

Some methods have been developed to provide for strict control of the usage of such payment instruments by subordinate parties. For instance, controlled payment numbers may be issued that operate as traditional payment card numbers, but are associated with a specific transaction account and are subject to controls set by the consumer associated with the account. Such controls can include overall spending limits, transactional spending limits, limits on transaction frequency, limits on merchant categories, geographic limits, time and/or date limits, etc. These controls can enable a supervisory consumer to provide a payment card to a subordinate consumer with the assurance that limits set by the supervisor will not be exceeded.

However, there may be instances where a strict control may not be desirable. For example, an unexpected expense may arise that a supervisor may be willing to let their subordinate pay for, but which may be prohibited by the controls set forth on the payment instrument provided to the subordinate. In many control schemes, the subordinate must first inform the supervisor of the expense prior to conducting the transaction, the supervisor must contact their financial institution to change the controls on the instrument, the financial institution must change the controls, and then the transaction may be initiated. Not only can this process be time consuming, which can delay transactions that, in some instances, may be time-sensitive, but the result is that the controls on the card have been modified. Thus, if the supervisor does not want the modification to be permanent, they must repeat the process in order to revert the controls back to their original state.

Thus, there is a need for a technical solution to enable a supervisory consumer to supervise usage of a payment instrument on a per-transaction basis if the transaction exceeds a previously set threshold, where the supervisory consumer may authorize or decline the transaction as it occurs. Such a solution may provide for authorization of a transaction that exceeds a limit that is faster and more efficient than existing control methods, and can also be performed on a per-transaction basis such that modification to the overall control scheme is unnecessary, which may provide for faster and more efficient control overall.

### SUMMARY

The present disclosure provides a description of computer implemented systems and methods for supervisory control of payment transactions initiated using a computing device.

A computer implemented method facilitating supervisory control of payment transactions initiated using a computing device includes: storing, in an account database, a plurality of account profiles, wherein each account profile includes data related to a consumer account including at least a first identifier directing electronic communications to a first computing device associated with the related consumer account, a second identifier directing electronic communications to a second computing device associated with the related consumer account, and one or more consumer designated transaction controls; receiving, by a receiving device, transaction details from a second computing device for a payment transaction via a communication network using one or more associated communication protocols, wherein the transaction details include at least a specific second identifier and one or more transaction data values; identifying, by a processing device, a specific account profile stored in the account database where the included second identifier corresponds to the specific second identifier included in the received transaction details; determining, by the processing device, that the payment transaction does not satisfy the one or more consumer designated transaction controls included in the identified specific account profile based on a correspondence between the one or more consumer designated transaction controls and the one or more transaction data values included in the received transaction details; transmitting, by a transmitting device, a confirmation request to the first computing device associated with the first identifier included in the identified specific account profile via a communication network using one or more associated communication protocols, wherein the confirmation request includes at least the one or more transaction data values; receiving, by the receiving device, a confirmation message from the first computing device associated with the first identifier included in the identified specific account profile via a communication network using one or more associated communication protocols, wherein the confirmation message includes an indication of approval or denial of the payment transaction; and transmitting, by the transmitting device, a message to at least one of: the second computing device associated with the specific second identifier, a payment network, and a merchant involved in the payment transaction based on the indication of approval or denial of the payment transaction.

A computer system facilitating supervisory control of payment transactions initiated using a computing device includes an account database, a receiving device, a processing device, and a transmitting device. The account database is configured to store a plurality of account profiles, wherein each account profile includes data related to a consumer account including at least a first identifier directing electronic communications to a first computing device associated with the related consumer account, a second identifier directing electronic communications to a second computing device associated with the related consumer account, and one or more transaction controls. The receiving device is configured to receive transaction details from a second computing device for a payment transaction via a communication network using one or more associated communication protocols, wherein the transaction details include at least a specific second identifier and one or more transaction data values. The processing device is configured to: identify a specific account profile stored in the account database where the included second identifier corresponds to the specific second identifier included in the received transaction details; and determine that the payment transaction does not satisfy the one or more transaction controls included in the identified specific account profile based on a correspondence between the one or more transaction controls and the one or more transaction data values included in the received transaction details. The transmitting device is configured to transmit a confirmation request to the first computing device associated with the first identifier included in the identified specific account profile via a communication network using one or more associated communication protocols, wherein the confirmation request includes at least the one or more transaction data values. The receiving device is further configured to receive a confirmation message from the first computing device associated with the first identifier included in the identified specific account profile via a communication network using one or more associated communication protocols, wherein the confirmation message includes an indication of approval or denial of the payment transaction. The transmitting device is further configured to transmit a message to at least one of: the second computing device associated with the specific second identifier and a payment network based on the indication of approval or denial of the payment transaction.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for supervisory control of payment transactions using computing devices in accordance with exemplary embodiments.

FIG. 2 is a block diagram illustrating the processing server of FIG. 1 for facilitating supervisory control of payment transactions using computing devices in accordance with exemplary embodiments.

FIG. 3 is a flow diagram illustrating a process for providing supervisory control of a payment transaction using multiple computing devices using the system of FIG. 1 in accordance with exemplary embodiments.

FIG. 4 is a flow diagram illustrating a process for providing supervisory control of a payment transaction using multiple computing devices using the processing server of FIG. 2 in accordance with exemplary embodiments.

FIG. 5 is a flow chart illustrating an exemplary computer implemented method for facilitating supervisory control of payment transactions initiated using a computing device in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal , etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal , etc.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Controlled Payment Number—Controlled payment numbers may be payment numbers associated with a payment account that are subject to one or more rules. In many cases, these rules may be set by a cardholder, such as spending limits, limits on days and/or times of a transaction, limits on merchants or industries, transaction spending or frequency limits, etc. Controlled payment numbers may offer an account holder an opportunity to give payment cards tied to the account to others for use, but subject to rules set by the cardholder, such as an employer distributing cards to employees, or a parent distributing cards to children. Additional detail regarding controlled payment numbers may be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. patent application Ser. No. 12/219,952, filed Jul. 30, 2008; U.S. patent application Ser. No. 12/268,063, filed Nov. 10, 2008; and U.S. patent application Ser. No. 12/359,971, filed Jan. 26, 2009; each of which are herein incorporated by reference in their entirety.

### System for Supervisory Control of Payment Transactions

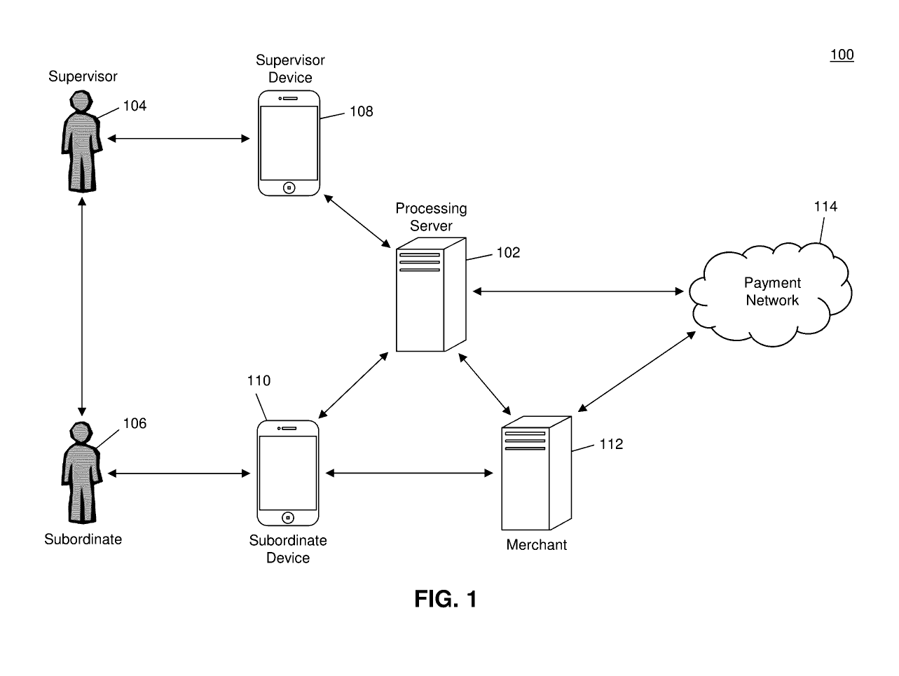

FIG. 1 illustrates a system 100 for the supervisory control of payment transactions that exceed a previously determined threshold using computing devices.

The system 100 may include a processing server 102. The processing server 102, discussed in more detail below, may be configured to provide for supervisory control of payment transactions based on transaction values and consumer designated transaction controls, where supervisory control may be accomplished using computing devices. In the system 100, a supervisor 104 may provide payment details for a transaction account to which the supervisor 104 is associated to a subordinate 106. The supervisor 104 and subordinate 106 may be, for example, a parent and child, an employer and employee, or any two consumers where the subordinate 106 may conduct a payment transaction that is to be supervised by the supervisor 104.

The supervisor 104 may register a transaction account for supervision with the processing server 102. As part of the registration, the supervisor 104 may provide at least a device identifier associated with a supervisor device 108 to the processing server 102. The device identifier may be a unique value suitable for use in directing electronic communications from the processing server 102 to the associated supervisor device 108, such as a media access control address, internet protocol address, email address, phone number, username, etc. The supervisor 104 may register the supervisor device 108 as a device used for the supervising of transactions involving the subordinate 106. The supervisor device 108 may be any type of computing device suitable for performing the functions disclosed herein, such as a desktop computer, laptop computer, notebook computer, tablet computer, cellular phone, smart phone, smart watch, smart television, wearable computing device, implantable computing device, etc.

As part of the registration process, the supervisor 104 may provide account information for the registered transaction account, such as a transaction account number. The supervisor 104 may also set one or more transaction controls regarding usage of the transaction account by the subordinate 106. The transaction controls may be any suitable type of control that may be placed on one or more payment transactions, such as a transaction spending limit, aggregate spending limit, transaction frequency limit, merchant limit, merchant category limit, geographic location limit, purchase type limit, individual product limit, transaction type limit, etc. Types of transaction controls that may be set for control of payment transactions will be apparent to persons having skill in the relevant art.

In some instances, registration may include the supervisor 104 providing a device identifier for a subordinate device 110 associated with a subordinate 106 to whom account access is provided. In some cases, the subordinate 106 may provide the device identifier for the subordinate device 110 directly to the processing server 102. For example, the supervisor 104 may provide authentication information to the subordinate 106 for use in authenticating the subordinate device 110 as an authorized device. Methods for registration of a computing device will be apparent to persons having skill in the relevant art.

In some embodiments, the transaction controls may be set on a per-subordinate basis. For example, the supervisor 104 may provide payment details for the transaction account to multiple subordinates 106, such as an employer providing payment cards associated with a corporate account to several employees. In such embodiments, the supervisor 104 may set transaction controls that are specific to one or more subordinates 106. In some instances, the supervisor 104 may set transaction individual-specific transaction controls as well as overall account transaction controls. For example, the supervisor 104 may set an individual aggregate spending limit for each subordinate 106, as well as an overall spending limit for the transaction account. In such instances where multiple subordinates 106 may be associated with a transaction account, multiple subordinate devices 110 may be registered with the processing server 102 and associated with the transaction account. In some cases, an individual subordinate 106 may be associated with multiple subordinate devices 110.

In some embodiments, the supervisor device 108 may transmit a registration request to the processing server 102 comprising registration data, such as an account identifier and a device identifier. In some embodiments, the supervisor device 108 may provide a display prompting a user (e.g., the supervisor 104) to register with the processing server 102. For instance, a supervisor 104 may input registration data at the display of the supervisor device 108, via a man-machine interface (e.g., a web page, an interface of an application program stored on the supervisor device 108, etc.). In some instances, registration information (e.g., a device identifier, an account identifier, etc.) may be transmitted by the supervisor device 108 to the processing server 102 without the requirement for user input (e.g., an application installed on the supervisor device 108 may execute a process to identify and transmit a device identifier of the supervisor device 108 to the processing server 102, etc.). In some embodiments, the registration process may be performed by a user device other than the supervisor device 108 so long as the user device is configured to communicate with the processing server 102 to transmit the registration data. For example, the supervisor 104 may register with a desktop computer, but may use the supervisor device 108 when supervising transactions.

The supervisor device 108 may comprise, e.g., an input and a display. The supervisor device 108 may further comprise a memory and a processing device. The supervisor device 108 may be configured to display data associated with a method for facilitating supervisory control of payment transactions on the display of the supervisor device 108. The data displayed may, e.g., comprise some or all of: a prompt for registration information, login credentials, transaction information, transaction control information, responses to requests for authorization (e.g., icons with which the supervisor 102 may interact to decline or authorize a request for a transaction initiated by a subordinate device 110), notifications, and any other information that may be relevant to the methods disclosed herein. In some embodiments, the data may be displayed on the display of the supervisor device 108, for instance, via a web application or application software running on the supervisor device 108. The supervisor device may be configured to transmit data received via an input of the device to the processing device 102. The supervisor device 108 may be configured to communicate with the processing server 102 to update information previously transmitted to the processing server 102 (e.g., transaction control parameters, etc.) from time to time.

Once the transaction account has been registered and the transaction controls set by the supervisor 104, the subordinate 106 may use the subordinate device 110 to begin a payment transaction with a merchant 112. The subordinate 106 may use an application program on the subordinate device 110, such as a web browsing application program or other specially configured application program, to select products (e.g., goods or services) for purchase using methods that will be apparent to persons having skill in the relevant art. In some embodiments, the application program may be downloaded and installed on the subordinate device 110. When the subordinate 106 has selected products for purchase and is ready to initiate processing of the payment transaction, transaction details for the payment transaction may be submitted from the subordinate device 110 to the processing server 102. The transaction details may be submitted via a communication network using associated communication protocols, such as a cellular network, mobile communication network, the Internet, etc. The transaction details may include the transaction amount, a time and/or date, geographic location of the subordinate device 110, data associated with the merchant 112, such as a merchant name, merchant identification number, merchant category code, geographic location, etc., and any other data associated with the transaction that may be subject to controls set by the supervisor 104. The subordinate device 110 may be any type of computing device suitable for performing the functions disclosed herein, such as a desktop computer, laptop computer, notebook computer, tablet computer, cellular phone, smart phone, smart watch, smart television, wearable computing device, implantable computing device, etc. The subordinate device 110 may comprise, e.g., an input and a display. The subordinate device 110 may further comprise a memory and a processing device.

The processing server 102 may receive the transaction details and may identify the transaction controls set by the supervisor 104 for the transaction. The transaction controls may be identified based on the device identifier for the subordinate device 110 used to transmit the transaction details, or information included in the transaction details, such as an identifier associated with the transaction account. Such an identifier may be the transaction account number, or may be another identifier that may be used in place of the transaction account number, such that payment details or other financial information may not be transmitted by the subordinate device 110. [0031]The processing server 102 may then analyze the transaction details and the transaction controls to determine if the payment transaction satisfies the transaction controls set by the supervisor 104. If the transaction controls are satisfied, then the payment transaction may be initiated. In one embodiment, the processing server 102 may transmit a notification to the subordinate device 110 that the transaction is authorized to proceed, and the subordinate device 110 may initiate the payment transaction with the merchant 112, who may generate an authorization request for the payment transaction and submit it to a payment network 114 for processing. For example, the subordinate device 110 may transmit the payment details to the merchant 112 via near field communication (NFC). In another example, the subordinate device 110 may display a machine-readable code encoded with payment details that may be read by the merchant 112 for conveyance of payment details, such as described in more detail in U.S. patent application Ser. No. 13/299,774, entitled “Financial Card Method, Device and System Utilizing Bar Codes to Identify Transaction Details,” filed on Nov. 18, 2011, which is herein incorporated by reference in its entirety. In another embodiment, the processing server 102 may transmit the transaction details directly to the merchant 112, who may then generate and submit the authorization request. In yet another embodiment, the processing server 102 may generate the authorization request using the transaction details and submit it directly to the payment network 114. The payment network 114 may then process the payment transaction using methods and systems that will be apparent to persons having skill in the relevant art. In some embodiments, the processing server 102 may be a part of the payment network 114.

If the processing server 102 determines that the transaction controls for the payment transaction are not satisfied, then the processing server 102 may transmit the transaction details or information included therein to the supervisor device 108. In some instances, only transaction details relevant to the exceeded transaction control or controls may be transmitted to the supervisor device 108. The information may be transmitted to the supervisor device 108 using one or more communication networks and associated communication protocols usable by the supervisor device 108 and the processing server 102. Once received, the supervisor device 108 may display the transaction details to the supervisor 104. The supervisor device 108 may then receive decision data via input of the supervisor device 108 by the supervisor 104 (e.g., in response to a prompt displayed on the supervisor device 108) indicating whether the transaction is authorized or denied. The supervisor 104 may input the decision data into the supervisor device 108, which may then electronically transmit the decision data to the processing server 102 using the communication network and associated protocols.

The processing server 102 may receive the decision data from the supervisor device 108 and may process it accordingly. If the decision data indicates that the transaction is authorized, the payment transaction may be processed using the methods discussed above. If the decision data received indicates that the transaction is not authorized or declined , the processing server 102 may notify the subordinate 106 via the subordinate device 110. A notification may be transmitted to the subordinate device 110 via the communication network, which may indicate to the subordinate 106 that the transaction was denied (e.g., by causing the subordinate device 110 to display a notification on the display of the subordinate device 110). In some instances, the notification may indicate that the transaction was denied because of the transaction controls. In other instances, the supervisor 104 may provide a notification message or reasoning, which may be submitted when the decision is input to the supervisor device 108 and transmitted to the processing server 102 for inclusion in the notification. For instance, in some embodiments, a web application or application stored in a memory of the supervisor device 108 may cause the display to provide a prompt displaying options for approval or denial of a payment transaction of a subordinate device 110 along with an input field for receiving user-input information related to the request. In such embodiments, a user of the supervisor device 108 may input data into the input field which is transmitted to the processing server 102. The processing server 102 may transmit the user provided message to the subordinate device 110, wherein the message is displayed thereon. In some embodiments, additional transaction information related to the authorization or denial of the transaction may be transmitted to the subordinate device 110 and displayed along with or in connection with the user-input message.

The methods and systems discussed herein provide for supervisory control of payment transactions via computing devices, whereby transaction details for a payment transaction are entered in the subordinate device 110, with the processing server 102 determining if the transaction is to proceed based on transaction controls set forth by the supervisor 104. If the controls are exceeded, the supervisor 104 is provided with the opportunity to authorize or decline the transaction using the supervisor device 108. If the transaction is authorized, the processing server 102 initiates the payment transaction such that payment transactions that would normally exceed controls can be authorized by the supervisor 104 using their supervisor device 108. As a result, the methods and systems discussed herein enable transaction controls while also enabling supervisors to authorize transactions that exceed controls, without permanently changing the controls and on a per-transaction basis, facilitating transactions using faster, and more efficient processing than traditional systems by virtue of the processing server 102 and the system configurations discussed herein.

### Processing Server

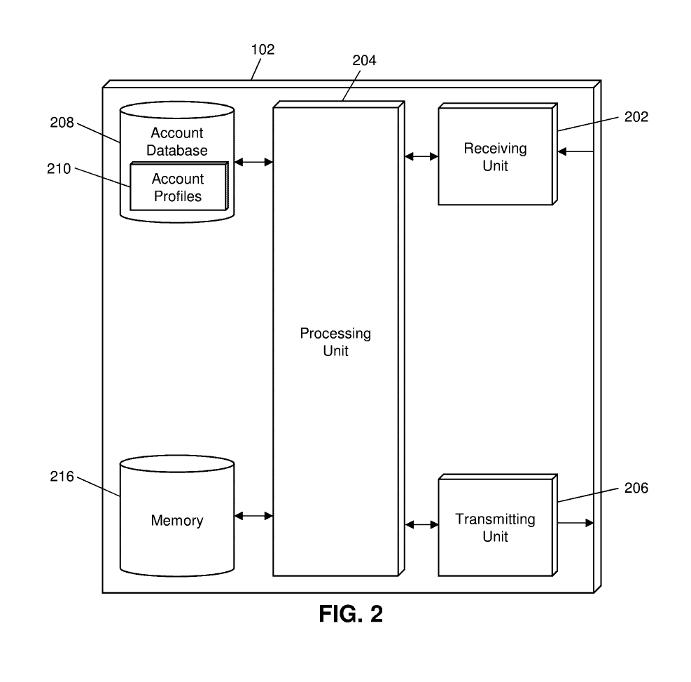

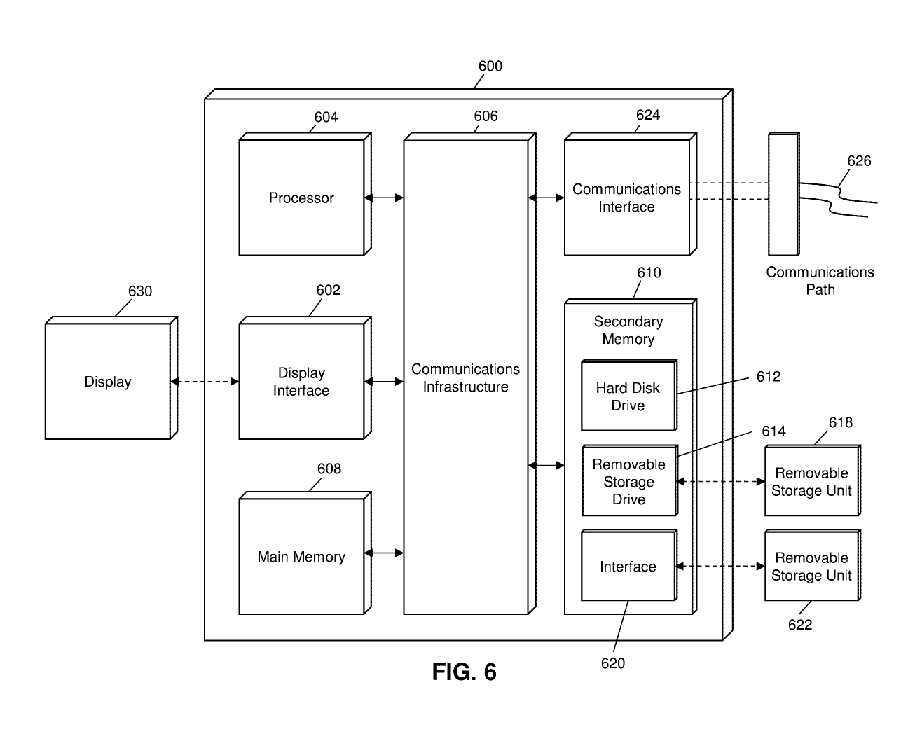

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving unit 202. The receiving unit 202 may be configured to receive data over one or more networks via one or more network protocols. Data received by the receiving unit 202 may be formatted using any suitable standard and/or protocol and transmitting using any suitable communication network, such as cellular networks, mobile communication networks, the Internet, Bluetooth, radio frequency, near field communication, etc. The receiving unit 202 may receive registration data from the supervisor device 108 and/or subordinate device 110, which may include device identifiers. The receiving unit 202 may also receive transaction controls from the supervisor 104, such as via the supervisor device 108. The receiving unit 202 may be further configured to receive transaction details for payment transactions from subordinate devices 110. In some embodiment, the receiving unit 202 may be configured to receive transaction messages transmitted using associated communication networks and protocols. In such embodiments, transaction details may be transmitted in a transaction message.

The processing server 102 may also include an account database 208. The account database 208 may be configured to store a plurality of account profiles 210. Each account profile 210 may include data related to a consumer account, such as data identifying a transaction account, and may include at least a first identifier, a second identifier, and one or more transaction controls. The first identifier may be a supervisor identifier associated with a supervisor device 108 suitable for use in directing electronic communications to the supervisor device 108. The second identifier may be a subordinate identifier associated with the subordinate device 110 suitable for use in directing electronic communications to the subordinate device 110. The transaction controls may be controls set by the supervisor 104 associated with the related consumer account for which payment transactions involving the related consumer account may be subject to. In some embodiments, an account profile 210 may include a plurality of subordinate identifiers. In such embodiments, the account profile 210 may also include transaction controls associated with individual subordinate identifiers and/or groups of subordinate identifiers.

The processing server 102 may also include a processing unit 204. The processing unit 204 may be configured to perform the functions of the processing server 102 discussed herein as will be apparent to persons having skill in the relevant art. The processing server 102 may be configured to generate an account profile 210 for storage in the account database 208 upon receipt of registration information by the receiving unit 202 (e.g., from the supervisor device 108 or other computing device associated with the supervisor 104). In some instances, registration information may comprise a supervisor identifier and one or more transaction controls. In such instances, one or more subordinate identifiers may be added to an account profile 210 following further registration of subordinate devices 110, with associated data received by the receiving unit 202. In some instances, a subordinate device 110 may be registered by the processing server 102 in response to a registration request received from the supervisor device 108. In other instances, the registration request may be received from the subordinate device 110. In some cases, one or more separate computing devices may be used to submit registration requests to the processing server 102, such as a separate computing device used by the supervisor 104 and/or subordinate 106.

The processing unit 204 may also be configured to identify account profiles 210 stored in the account database 208 upon receipt of transaction details by the receiving unit 202. When the receiving unit 202 receives transaction details for a payment transaction, the processing unit 204 may identify a subordinate identifier included therein and may execute a query on the account database 208 to identify an account profile 210 that includes a subordinate identifier that corresponds to the subordinate identifier included in the received transaction details. The processing unit 204 may then analyze transaction data values included in the received transaction details as compared to the one or more transaction controls included in the identified account profile 210 to determine if the transaction controls are satisfied by the transaction. The processing unit 204 may be further configured to perform one or more actions based on the determination. For instance, if the transaction controls are satisfied, the payment transaction may be continued. For example, the subordinate device 110 and/or merchant 112 may be notified (e.g., by an electronic message received at the subordinate device and/or a merchant device) and the payment transaction processed using traditional systems and methods. If the transaction controls are not satisfied, the supervisor 104 associated with the related consumer account may be notified and authorization for the transaction requested.

The processing server 102 may also include a transmitting unit 206. The transmitting unit 206 may be configured to transmit data over one or more networks via one or more network protocols. The transmitting unit 206 may transmit transaction details for payment transactions to supervisor devices 108, such as in instances where account controls for a related transaction account are not satisfied by an associated payment transaction. The transmitting unit 206 may also be configured to transmit notifications to subordinate devices 110. Notifications may include notifications that a transaction is denied, and notifications that a transaction is authorized. Such notifications may include instructions transmitted to associated application programs to deny a transaction or to initiate a transaction (e.g., to cause the subordinate device 110 to submit the transaction to the merchant 112 and/or payment network 114, if authorized). For instance, in some embodiments, a notification may be transmitted to the subordinate device 110 and the subordinate device may display the notification on the display of the subordinate device 110. The notification may prompt the subordinate 104 and/or the subordinate device 110 to proceed by transmitting transaction information to the merchant 112 and/or the payment network 114. The subordinate device 110 may be automatically prompted to transmit transaction information or may transmit transaction information in response to user input (e.g., received at an input of the subordinate device 110 from a subordinate 104). In some embodiments, the transaction information may be communicated to the merchant 112 and/or the payment network 114 via near field communication (NFC). In some instances, the transaction information or data representative of the transaction information may be displayed on the display of the subordinate device 110 and received by a reader of the merchant device 112. For example, the subordinate device 110 may generate and display a machine-readable code encoded with transaction information, payment details, and/or other suitable information that may be read by a suitable device of the merchant 112.

In some embodiments, the transmitting unit 206 may be configured to transmit transaction details for the merchant 112. In some instances, the transmitting unit 206 may be configured to transmit transaction details to the payment network 114. In some cases, transaction details may be transmitted to the payment network 114 as part of an authorization request. In such cases, the processing unit 204 may be configured to generate the authorization request, which may be a transaction message formatted pursuant to one or more associated standards (e.g., the International Organization for Standardization's ISO 8583 standard) and include data elements configured to store transaction details. The authorization request may be transmitted to the payment network 114 by the transmitting unit 206 using associated protocols, and processed by the payment network 114 accordingly. In some instances, the receiving unit 202 may receive an authorization response for the transaction, which may be forwarded to the subordinate device 110 and/or merchant 112 by the transmitting unit 206.

The processing server 102 may also include a memory 216. The memory 216 may be configured to store data suitable for performing the functions of the processing server 102 as discussed herein. For example, the memory 216 may store rules and/or algorithms for analyzing transaction details, transaction control algorithms, transaction control templates, communication protocol and standard data, notification rules, etc. Additional data that may be stored in the memory 216 will be apparent to persons having skill in the relevant art.

### Process for Facilitating Supervisory Control of Payment Transactions

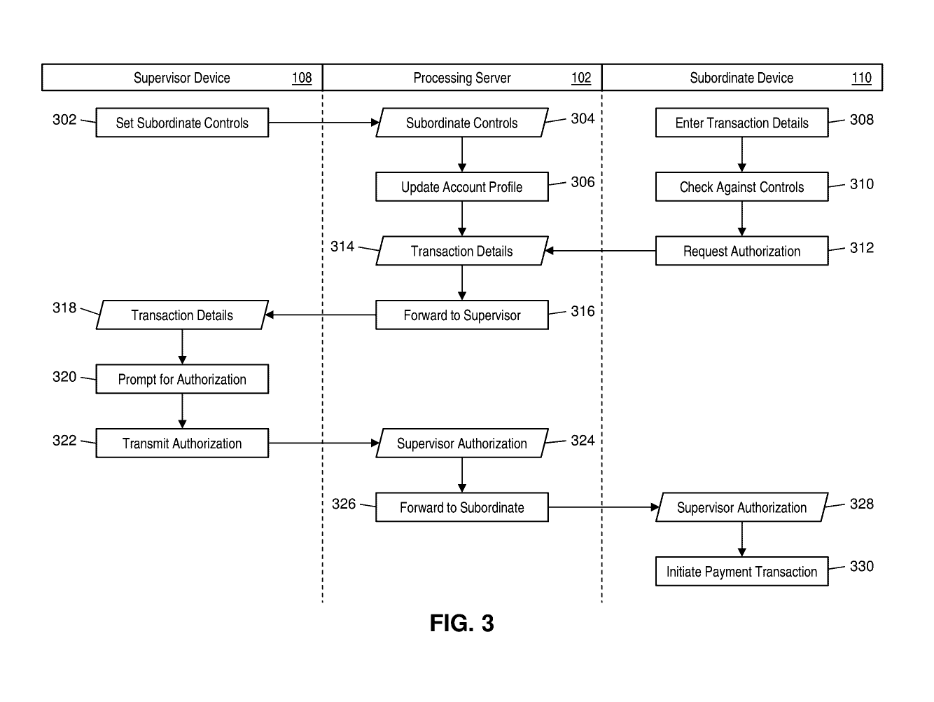

FIG. 3 illustrates a process for the supervisory control of payment transactions implemented using the processing server 102, supervisor device 108, and subordinate device 110 of the system 100.

In step 302, the supervisor 104 may set one or more transaction controls for the subordinate 110 using the supervisor device 108. The controls and a device identifier associated with the supervisor device 108 may be submitted to the processing server 102, and, in step 304, received by the receiving unit 202 of the processing server 102. In step 306, the processing unit 204 of the processing server 102 may query the account database 208 to identify an account profile 210 that includes a supervisor identifier that corresponds to the device identifier electronically communicated by the supervisor device 108, and may update the transaction controls stored in the identified account profile 210 based on the controls received from the supervisor device 108. In some instances, the supervisor device 108 may also provide the device identifier associated with the subordinate device 110, which may also be stored in the identified account profile 210.

In step 308, the subordinate 106 may select goods or services for a payment transaction into the subordinate device 110. For example, the subordinate device 110 may include program code for an application program configured to enable the subordinate 106 to select one or more products for purchase. In step 310, the transaction details may be checked for satisfaction of the transaction controls set by the supervisor 104. In one embodiment, the transmitting unit 206 of the processing server 102 may forward the transaction control data to the subordinate device 110 for checking, such that, if the transaction controls are satisfied, the transaction may be submitted to the merchant 112 without involving the processing server 102. In some instances, the transaction controls transmitted to the subordinate device 110 may be displayed on a display device thereof. In another embodiment, the subordinate device 110 may transmit the transaction details to the processing server 102 for checking, which may be performed by the processing unit 204, with the transmitting unit 206 transmitting a notification to the subordinate device 110 indicative of the result of the check. In some instances, the notification may be displayed on a display device of the subordinate device 110, such as via text or other suitable form of notification, such as the flashing of a light, changing of a color, playing of a sound, etc.

If the check determines that the transaction controls are not satisfied by the transaction (e.g., one or more limits set by the supervisor 104 are exceeded or otherwise not met), then, in step 312, the subordinate device 110 may submit a request for authorization to the processing server 102. The request may be electronically transmitted to the processing server 102 via a communication network and received by the receiving unit 202, in step 314. The request may comprise the transaction details for the payment transaction that were previously entered into the subordinate device 110 by the subordinate 106. In some instances, the details included in the request may be received by the subordinate device 110 via an input of the device. In such instances, details of the transaction may be received by one or more inputs of the subordinate device configured to receive data by, e.g., reading a QR code, Near Field Communication (NFC), manual entry, etc.

In step 316, the transmitting unit 206 may forward the transaction details, or data included therein, to the supervisor device 108 via the communication network. In step 318, the supervisor device 108 may receive the data provided by the processing server 102. In step 320, the supervisor device 108 may display the data to the supervisor 104 and may prompt the supervisor 104 to authorize or deny the payment transaction. Data displayed to the supervisor 104 may include, for example, the merchant name, transaction amount, product data, offer data, geographic location of the subordinate device 110, etc. In step 322, authorization may be received from the supervisor 104 and may be transmitted by the supervisor device 108 to the processing server 102 via the communication network. The receiving unit 204 of the processing server 102 may receive the authorization, in step 324.

In step 326, the transmitting unit 206 may forward the authorization to the subordinate device 110. In step 328, the subordinate device 110 may receive the authorization from the supervisor 104 and proceed with the transaction, where, in step 330, the payment transaction may be initiated by submitting the transaction details to the merchant 112. The transaction may then be processed using traditional methods and systems that will be apparent to persons having skill in the relevant art. In some embodiments, the transaction may be submitted to the merchant 112 and/or payment network 114 with an indication that the transaction controls are satisfied (e.g., by virtue of the supervisor's authorization).

### Facilitating Supervisory Control of a Payment Transaction

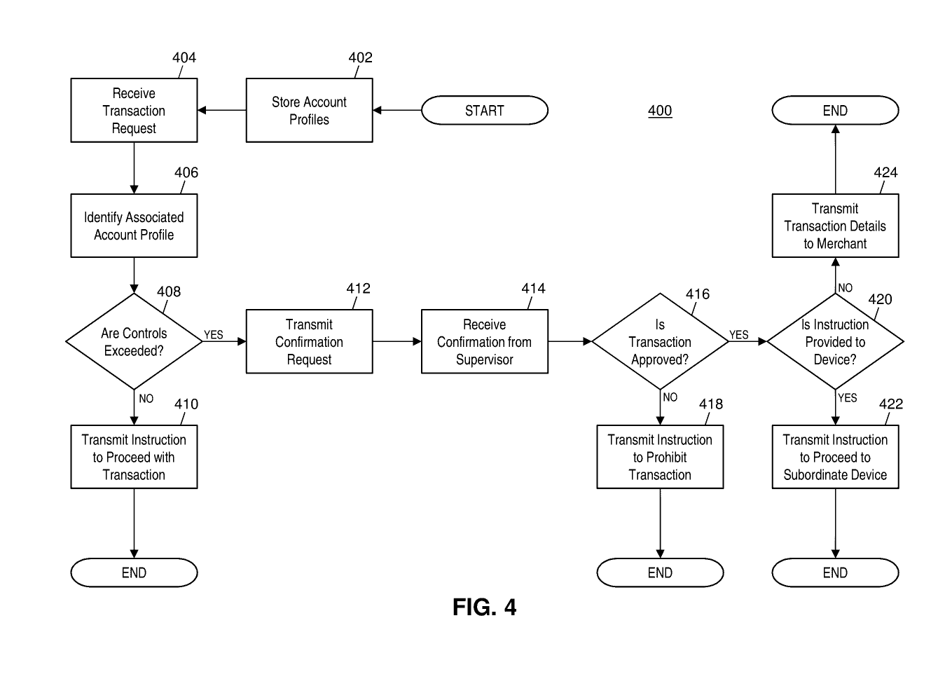

FIG. 4 illustrates a process 400 for the facilitation of supervisory control of a payment transaction using the processing server 102.

In step 402, account profiles 210 may be stored in the account database 208 of the processing server 102. Each account profile 210 may include data related to a consumer account including at least a supervisor identifier, one or more subordinate identifiers, and one or more transaction controls. In step 404, the receiving unit 202 of the processing server 102 may receive a transaction request from a subordinate device 110. The transaction request may include at least a subordinate identifier associated with the subordinate device 110 and one or more transaction data values associated with the transaction and/or transaction controls, such as a transaction amount, transaction time and/or date, merchant identification number, merchant category code, geographic location, etc.

In step 406, the processing unit 204 of the processing server 102 may execute a query on the account database 208 to identify a specific account profile 210 that includes a subordinate identifier that corresponds to the subordinate identifier included in the received transaction request. In step 408, the processing unit 204 may determine if the transaction controls included in the identified specific account profile 210 are exceeded or otherwise violated by the payment transaction based on the transaction data values included in the received transaction request and parameters associated with the transaction controls. If the transaction controls are not exceeded, then, in step 410, the transmitting unit 206 may transmit an instruction to the subordinate device 110 to proceed with the payment transaction.

If the transaction controls are exceeded, then, in step 412, the transmitting unit 206 may transmit a confirmation request to the supervisor device 108 associated with the supervisor identifier included in the identified specific account profile 210. In step 414, the receiving unit 202 may receive a confirmation message (e.g., input by the supervisor 104) via the supervisor device 108 via a suitable communication network, such as a cellular communication network or the Internet. In step 416, the processing unit 204 may determine if the transaction is approved by the supervisor 104 based on the confirmation received from the supervisor device 108. If the transaction is not approved (e.g., the confirmation indicates that the transaction is denied), then, in step 418, the transmitting unit 206 may transmit an instruction to the subordinate device 110 to prohibit proceeding with the payment transaction.

If the transaction is approved, then, in step 420, the processing unit 204 may determine if an instruction to proceed is to be transmitted to the subordinate device 110. The determination may be based on account settings (e.g. stored in the identified specific account profile 210), system settings (e.g., stored in the memory 216), merchant settings associated with the merchant 112 involved in the payment transaction, etc. If the subordinate device is to receive the instruction, then, in step 422, the transmitting unit 206 may transmit the instruction to the subordinate device 110 to proceed with the transaction. If the subordinate device is not to receive the instruction, then, in step 424, the transaction details for the payment transaction may be transmitted directly to the merchant 112. The merchant 112 may then proceed with processing the payment transaction using traditional methods. In some embodiments, an authorization request may be transmitted directly to the payment network 114 (e.g., without performing steps 422 or 424) by the processing server 102.

### Exemplary Computer Implemented Method for Facilitating Supervisory Control of Payment Transactions Initiated Using a Computing Device

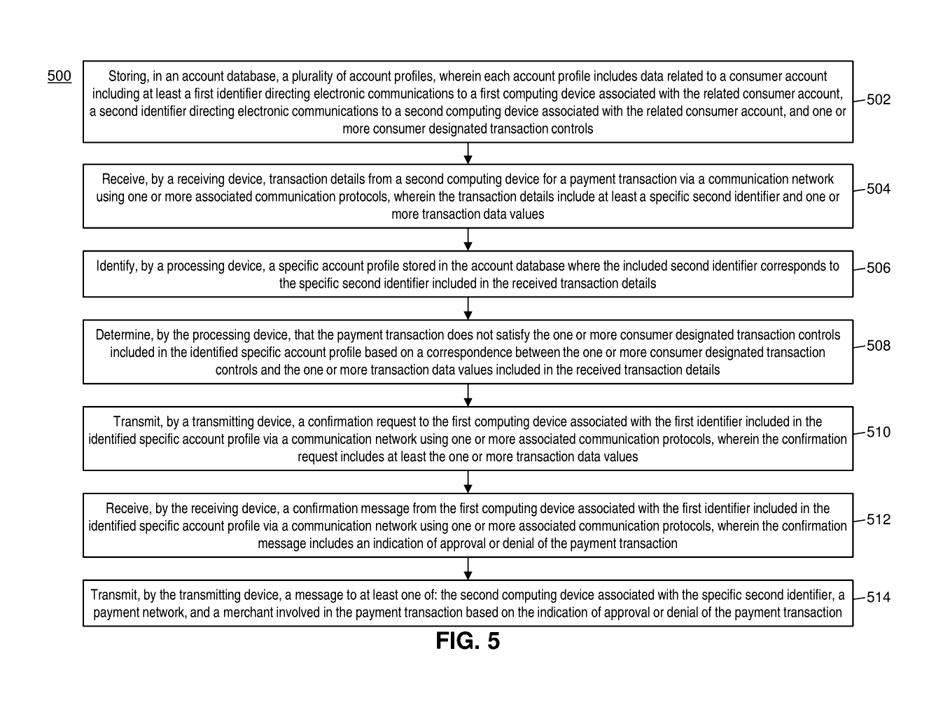

FIG. 5 illustrates a computer implemented method 500 for facilitating supervisory control of a payment transaction using a first computing device, with the payment transaction initiated using a second computing device, if the payment transaction exceeds previously determined transaction controls.

In step 502, a plurality of account profiles (e.g., account profiles 210) may be stored in an account database (e.g., the account database 208), wherein each account profile 210 includes data related to a consumer account including at least a first identifier directing electronic communications to a first computing device (e.g., the supervisor device 108) associated with the related consumer account, a second identifier directing electronic communications to a second computing device (e.g., the subordinate device 110) associated with the related consumer account, and one or more consumer designated transaction controls. In one embodiment, the one or more transaction controls may be based on at least one of: transaction amount, transaction time, transaction data, geographic location, merchant, merchant category, product, and product category.

In step 504, transaction details may be received by a receiving device (e.g., the receiving unit 202) from a second computing device 110 for a payment transaction via a communication network using one or more associated communication protocols, wherein the transaction details include at least a specific second identifier and one or more transaction data values. In one embodiment, the transaction data values may include at least one of: transaction amount, transaction time, transaction data, merchant name, merchant category code, merchant identification number, product data, and geographic location.

In step 506, a specific account profile 210 stored in the account database 208 may be identified by a processing device (e.g., the processing unit 204) where the included second identifier corresponds to the specific second identifier included in the received transaction details. In step 508, the processing device 204 may determine that the payment transaction does not satisfy the one or more consumer designated transaction controls included in the identified specific account profile 210 based on a correspondence between the one or more consumer designated transaction controls and the one or more transaction data values included in the received transaction details.

In step 510, a confirmation request may be transmitted by a transmitting device (e.g., the transmitting unit 206) to the first computing device 108 associated with the first identifier included in the identified specific account profile 210 via a communication network using one or more associated communication protocols, wherein the confirmation request includes at least the one or more transaction data values. In step 512, a confirmation message may be received by the receiving device 202 from the first computing device 108 associated with the first identifier included in the identified specific account profile 210 via a communication network using one or more associated communication protocols, wherein the confirmation message includes an indication of approval or denial of the payment transaction. In step 514, a message may be transmitted by the transmitting device 206 to at least one of: the second computing device 110 associated with the specific second identifier, a payment network (e.g., the payment network 114), and a merchant (e.g., the merchant 112) involved in the payment transaction based on the indication of approval or denial of the payment transaction.

In one embodiment, the message may be transmitted to the second computing device 110 associated with the specific second identifier and include an instruction instructing the second computing device 110 to (i) initiate processing of the payment transaction when the indication is an indication of approval of the payment transaction, or (ii) prohibit processing of the payment transaction when the indication is an indication of approval of the payment transaction. In some embodiments, when the indication included in the confirmation message is an indication of denial, the confirmation message may further include a reason for denial. In a further embodiment, the message may be transmitted to the second computing device 110 associated with the specific second identifier and may include at least the reason for denial.

In one embodiment, when the indication included in the confirmation is an indication of approval, the message may be transmitted to the payment network 114 and may be a transaction message formatted based on one or more standards, wherein the transaction message includes a plurality of data elements configured to store data including at least the one or more transaction data values. In a further embodiment, each account profile 210 may be further configured to store payment credentials associated with a transaction account associated with the related consumer account, and the plurality of data elements may include at least one data element configured to store the payment credentials included in the identified specific account profile 210.

In some embodiments, each account profile 210 may further include transaction data associated with a plurality of payment transactions involving the related consumer account. In a further embodiment, the correspondence used to determine that the payment transaction does not satisfy the one or more transaction controls included in the identified specific account profile 210 may be further between the one or more transaction controls, the one or more transaction data values included in the received transaction details, and the transaction data stored in the identified specific account profile 210.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for facilitating supervisory control of payment transactions initiated using a computing device. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A computer implemented method facilitating supervisory control of payment transactions initiated using a computing device, comprising:
storing, in an account database, a plurality of account profiles, wherein each account profile includes data related to a consumer account including at least a first identifier directing electronic communications to a first computing device associated with the related consumer account, a second identifier directing electronic communications to a second computing device associated with the related consumer account, and one or more consumer designated transaction controls;
receiving, by a receiving device, transaction details from a second computing device for a payment transaction via a communication network using one or more associated communication protocols, wherein the transaction details include at least a specific second identifier and one or more transaction data values;
identifying, by a processing device, a specific account profile stored in the account database where the included second identifier corresponds to the specific second identifier included in the received transaction details;
determining, by the processing device, that the payment transaction does not satisfy the one or more consumer designated transaction controls included in the identified specific account profile based on a correspondence between the one or more consumer designated transaction controls and the one or more transaction data values included in the received transaction details;
transmitting, by a transmitting device, a confirmation request to the first computing device associated with the first identifier included in the identified specific account profile via a communication network using one or more associated communication protocols, wherein the confirmation request includes at least the one or more transaction data values;
receiving, by the receiving device, a confirmation message from the first computing device associated with the first identifier included in the identified specific account profile via a communication network using one or more associated communication protocols, wherein the confirmation message includes an indication of approval or denial of the payment transaction; and
transmitting, by the transmitting device, a message to at least one of: the second computing device associated with the specific second identifier, a payment network, and a merchant involved in the payment transaction based on the indication of approval or denial of the payment transaction.

2. The method of claim 1, wherein the message is transmitted to the second computing device associated with the specific second identifier and includes an instruction instructing the second computing device to (i) initiate processing of the payment transaction when the indication is an indication of approval of the payment transaction, or (ii) prohibit processing of the payment transaction when the indication is an indication of denial of the payment transaction.

3. The method of claim 1, wherein, when the indication included in the confirmation message is an indication of approval, the message is transmitted to the payment network and is a transaction message formatted based on one or more standards, wherein the transaction message includes a plurality of data elements configured to store data including at least the one or more transaction data values.

4. The method of claim 3, wherein
each account profile is further configured to store payment credentials associated with a transaction account associated with the related consumer account, and
the plurality of data elements includes at least one data element configured to store the payment credentials included in the identified specific account profile.

5. The method of claim 1, wherein, when the indication included in the confirmation message is an indication of denial, confirmation message further includes a reason for denial.

6. The method of claim 5, wherein the message is transmitted to the second computing device associated with the specific second identifier and includes at least the reason for denial.

7. The method of claim 1, wherein each account profile further includes transaction data associated with a plurality of payment transactions involving the related consumer account.

8. The method of claim 7, wherein the correspondence used to determine that the payment transaction does not satisfy the one or more transaction controls included in the identified specific account profile is further between the one or more transaction controls, the one or more transaction data values included in the received transaction details, and the transaction data stored in the identified specific account profile.

9. The method of claim 1, wherein the one or more transaction controls are based on at least one of: transaction amount, transaction time, transaction data, geographic location, merchant, merchant category, product, and product category.

10. The method of claim 1, wherein the one or more transaction data values include at least one of: transaction amount, transaction time, transaction date, merchant name, merchant category code, merchant identification number, product data, and geographic location.

11. A computer system facilitating supervisory control of payment transactions initiated using a computing device, comprising:
an account database configured to store a plurality of account profiles, wherein each account profile includes data related to a consumer account including at least a first identifier directing electronic communications to a first computing device associated with the related consumer account, a second identifier directing electronic communications to a second computing device associated with the related consumer account, and one or more transaction controls;
a receiving device configured to receive transaction details from a second computing device for a payment transaction via a communication network using one or more associated communication protocols, wherein the transaction details include at least a specific second identifier and one or more transaction data values;
a processing device configured to
identify a specific account profile stored in the account database where the included second identifier corresponds to the specific second identifier included in the received transaction details, and
determine that the payment transaction does not satisfy the one or more transaction controls included in the identified specific account profile based on a correspondence between the one or more transaction controls and the one or more transaction data values included in the received transaction details; and
a transmitting device configured to transmit a confirmation request to the first computing device associated with the first identifier included in the identified specific account profile via a communication network using one or more associated communication protocols, wherein the confirmation request includes at least the one or more transaction data values, wherein
the receiving device is further configured to receive a confirmation message from the first computing device associated with the first identifier included in the identified specific account profile via a communication network using one or more associated communication protocols, wherein the confirmation message includes an indication of approval or denial of the payment transaction, and
the transmitting device is further configured to transmit a message to at least one of: the second computing device associated with the specific second identifier and a payment network based on the indication of approval or denial of the payment transaction.

12. The system of claim 11, wherein the message is transmitted to the second computing device associated with the specific second identifier and includes an instruction instructing the second computing device to (i) initiate processing of the payment transaction when the indication is an indication of approval of the payment transaction, or (ii) prohibit processing of the payment transaction when the indication is an indication of denial of the payment transaction.

13. The system of claim 11, wherein, when the indication included in the confirmation message is an indication of approval, the message is transmitted to the payment network and is a transaction message formatted based on one or more standards, wherein the transaction message includes a plurality of data elements configured to store data including at least the one or more transaction data values.

14. The system of claim 13, wherein
each account profile is further configured to store payment credentials associated with a transaction account associated with the related consumer account, and
the plurality of data elements includes at least one data element configured to store the payment credentials included in the identified specific account profile.

15. The system of claim 11, wherein, when the indication included in the confirmation message is an indication of denial, confirmation message further includes a reason for denial.

16. The system of claim 15, wherein the message is transmitted to the second computing device associated with the specific second identifier and includes at least the reason for denial.

17. The system of claim 11, wherein each account profile further includes transaction data associated with a plurality of payment transactions involving the related consumer account.

18. The system of claim 17, the correspondence used to determine that the payment transaction does not satisfy the one or more transaction controls included in the identified specific account profile is further between the one or more transaction controls, the one or more transaction data values included in the received transaction details, and the transaction data stored in the identified specific account profile.

19. The system of claim 11, wherein the one or more transaction controls are based on at least one of: transaction amount, transaction time, transaction data, geographic location, merchant, merchant category, product, and product category.

20. The system of claim 11, wherein the one or more transaction data values include at least one of: transaction amount, transaction time, transaction date, merchant name, merchant category code, merchant identification number, product data, and geographic location.
